(19) United States
(12) Patent Application Publication
(10) Pub. No.: US 2004/0054637 A1
(43) Pub. Date: Mar. 18, 2004

(54) Software synchronous specifying method, validating method, verifying method and testing method

(76) Inventor: Fumio Negoro, Kanagawa (JP)

Correspondence Address: HALE & DORR LLP, THE WILLARD OFFICE BUILDING, 1455 PENNSYLVANIA AVE, NW, WASHINGTON, DC, 20004, US

(21) Appl. No.: 10/432,232

(22) PCT Filed: Nov. 22, 2001
(86) PCT No.: PCT/JP01/10254

(30) Foreign Application Priority Data
Nov. 24, 2000 (JP) 2000-358405

(51) Int. Cl. G06F 17/00

(52) U.S. Cl. 706/45

(57) ABSTRACT

According to the present invention, an establishment is attained which is equivalent to performing endless repetition of such activities as specifying, validating, verifying and testing which are considered inevitable to make S/W a perfect product (as wished by the development requirer) in conventional method as well as a software which perfectly actualizes such development requirement avoiding such endless repetition, only by directly implementing with a programming language a law itself of Scenario Function which embraces semantic-quality determining mechanism by way of endless times of repetition structure.

### A TECHNICAL FIELD

The present invention relates, for example, to a software synchronous specifying method, validating method, verifying method and testing method concerning every business use or individual use.

### BACKGROUND ART

Conventionally, when an application business or an application function is implemented as a software against various configuration of processing unit, including standalone type, a client/server type, a client/front server/application server type for example, it is indispensable to establish structure dealing, without inconsistency, with various conflict (contention) events to be produced between the various request events that an application business and an application facility can potentially generate, and the various process events that can be guided from various configuration of processing units, and to express the structure by a sentence composed of words.

However, it is theoretically impossible to extract by the human being skill all of the request event, process event, conflict event arising between the aforementioned events, and dealing method thereagainst.

This is because it is impossible to grasp all of request events, process events and conflict events comprising of substantially endless (in comparison with the number of cells) number of elements (this element is nothing but a particle which composes the whole space, for example, and a phenomenon derived by the activities between particles each other), for a human existence, who conceives phenomena such as request event, a process event and a conflict event based on a limited number of the elements, or 60,000,000,000,000 cells, and after having determined in a heart the word that is an element of the sentence necessary to explain those phenomena, executes concrete behavior, namely uttering the words. The underlying mathematical principle supporting this argument is that “a small thing cannot grasp another thing bigger than itself in size, owing to the fact that the small one is smaller than the big one”.

Because all events cannot be caught by the human being skill, it is necessary for the person concerned with a software development, to grasp a request event, a process event and a conflict event within a conceivable range, to pursue an inconsist dealing method, and to implement the pursued result as a purpose software, by means of execution of activities (tasks) such as:

/specifying (specification definition),

/validating (authentication of legitimacy of the specification),

/verifying (exclusion of the wrong specification description) and

/testing (testing whether the result is made according to the specification).

The true nature of such an activity in nothing but to make a sentence for a description of a request event, a process event, a conflict event and dealing method, and to describe these by that sentence, which has grouped words as its subset according to the grammar.

This word is an element to compose a natural language. In order to describe these ecents without a leak or inconsistency by the sentence that has made the words grouped as its subset, it is indispensable that the words not only be appropriately chosen to exactly describe these events but also be selected without omission. For this purpose, the intention why the word was going to be used must be clear, and semantics of the word must be understood clearly.

However, the intention why a word was going to be used is buried in a heart of a person, which is anything but what the person in question much less another person can directly know. Because the intention cannot be directly known, an infinity times of monologues and questions/answers are necessary to catch the intention clearly.

In addition, if we consult a dictionary to understand semantics of a word clearly, it is the most difficult task in that there are many descriptive text in a dictionary in which the descriptive text chapter is a collection of a word. In other words, when we consult a dictionary to understand semantics of a first word, 50 times to 100 times as many as second words are to be necessary for explaining the first word. In this manner, there needs a third word whose number is 50 times to 100 times as many as that of the second words when we consult a dictionary to understand semantics of each of the second words whose number is already 50 times to 100 times more. When this is repeated, the correct semantics of the first word cannot be grasped unless a dictionary is investigated an infinite times for an examination about an infinite number of words. However, because infinity is nothing but limit being unsettled, eventually the semantics of a word gets infinite and unfixed. (these argument above is called Russel's paradox or Goedel's theory on uncertainity in a set theory).

In conclusion, “the approach to satisfy an intention of a development demand (a collection of words) in order to understand semantics of a word” is theoretically to be impossible unless Russel's paradox in a set theory is evaded.

In other words, the above-mentioned activity is needed so that a perfect product be implemented, where elements to realize the activity are both intention and semantics of a word. In order to perfect the word's intention and semantics, it is mandatory to prosecute a nearly infinite number of questions/answers both to oneself and to others as well as a nearly infinite number of investigation. But a nearly infinite number of repetitive activities are impossible in reality.

Then practically the prior art associated with software could not help but stay with a limited number of activities and follow a procedure in which a development demander and an engineer reach a provisional consensus against a limited range of specification which is composed as a result of the limited number of activities.

As a result, it is deemed that, in the prior art of software development method which could not help but get by a limited number of activities, a fundamental margin and inconsistency have existed in Q (quality), C (cost), D (delivery) themselves, which are considered an evaluation standard of “customer satisfaction degree” (CS), in that a perfect product cannot be realized until infinite number of activities are repeated.

As described above, in the first place, in the conventional software development, there was a problem that theoretical margin and inconsistency indwelled even at the starting point of how to catch development requirement in S/W implementation of a development demand.

### SUMMARY OF THE INVENTION

The present invention is made to solve the above-described problem of the prior-art and has an aim to annul that conventional theoretical margin and inconsistency.

Further object of the present invention is to achieve an accomplishment equivalent to those produced by specifying, validating, verifying and testing repeated by a limitless number of times, which are said to be necessary for making a perfect product (as demanded by a S/W development requirer), without actually practicing those activities.

In order to solve those problems, the present invention is characterized as comprising: a first step to determine sending information for displaying on a screen in a system to be developed; a second step to examine a data code in a data field recoding an identifier of W04 Pallet which edits the sending information; a third step, if as a result of the second step the sending information for displaying on a screen is a menu, to set all Pallets in the system as an object to be activated; a fourth step, if as a result of the second step the sending information for displaying on a screen is other than a menu, to initialize a used data field if needed (that is, a designation of new/continuation); a fifth step to activate W04 Pallet which edits the sending information; a sixth step to transmit to the screen the data code edited by the W04 Pallet in the fifth step; a seventh step to receive the input data code and the process instructions thereof operated on the screen; an eighth step to activate W02 Pallet which accepts the received data code and process instructions; a ninth step to activate either W03 Pallet or Pallet Chain Function associated with T1 in accordance with necessity; and a tenth step to repeat the first step to the ninth step endlessly up to system confinement.

“Pallet Chain Function”, one of components of Scenario Function that is a theoretical conclusion concerning the present invention, is what has a function to activate W02 Pallet Function, W03 Pallet Function and W04 Pallet Function and whose logical structure (programming structure, if this function comes true as a program) is predetermined regardless of a facility or a kind of object S/W to be produced.

The present invention, comprising the characteristics described above, achieves an accomplishment equivalent to the one brought about by a limitless number of repetition of activities such as specifying, validating, verifying and testing, all of which are conventionally needed to make a perfect product, only by way of implementing directly by a programming language the law of Scenario Function which involves semantic-quality determining structure through endless times of repetition.

### BRIEF DESCRIPTION OF THE DRAWINGS

FIG. 1 is a flowchart for explaining logical structure of Pallet Chain Function that is a component of Scenario Function concerning the present invention.

FIG. 2 is a flowchart for explaining logical structure of Pallet Function that is a component of Scenario Function concerning the present invention.

FIG. 3 is a flowchart for explaining logical structure of Tense Control Vector (Homogeneity Vector) that is a component of Scenario Function concerning the present invention.

FIG. 4 is a conceptual diagram explaining a relation between a development requirement, or a sentence in which words are collected into a set, and a processing unit, concerning one embodiment of the present invention.

FIG. 5 is a block diagram explaining a relation between a life operation and a life phenomenon when Tense Control Vector for each word, which is a third component of Scenario Function concerning one embodiment of the present invention, is considered a neuron performing a life operation.

FIG. 6 is a block diagram explaining the configuration of a program implemented concerning one embodiment of the present invention, and the operation order of the program.

FIG. 7 is a conceptual block diagram explaining a software wherein two processing units perform application operation or application function concerning one embodiment of the present invention in two parts, namely a client type and a server type.

FIG. 8 is a sequential chart for explaining a protocol necessary to attain one purpose between both life bodies concerning the present invention.

FIG. 9 is a conceptual block diagram explaining how in the present invention a word concerning a protocol is pasted into a predetermined (variable) identifier insertion point in each Pallet inside W04, W02 and W03, which all are a program to embody Scenario Function T1.

FIG. 10 is a conceptual block diagram for explaining from a standpoint of Scenario Function a S/W in which three processing units perform application operation or application function concerning one embodiment of the present invention in three parts, namely a client, a front server, and an application server.

FIG. 11 is a conceptual chart conceptually showing a way of thinking concerning one embodiment of the present invention.

### GENERAL DESCRIPTION OF THE INVENTION

A basis of the present invention is development methodology referred to as Lyee(“Lyee” is a registered trademark of THE INSTITUTE OF COMPUTER BASED SOFTWARE METHODOLOGY AND TECHNOLOGY), a part of which has been disclosed in PCT/JP96/03183, PCT/JP97/01492, PCT/JP99/01394, PCT/JP00/04008, Japanese Patent Application No. H11-321788 and Japanese Patent Application No. H12-160887. Scenario Function, which has been established as an internal law to determine semantic quality of a word in a development methodology referred to as Lyee, is expressed by the next expression.

$$\begin{matrix}T0 = Φ 0 ( + \{ Φ p \{ , L2 ( R , i ) , P 2 ( R , G ) , P 2 ( R , j ) \} \} R + \\ \{ Φ p \{ Y3 ( R , i ) R3 ( B , i ) , L3 ( R , i ) , L3 ( S , i ) P3 ( j ) , T1 \} \} + \\ \{ Φ p \{ Y4 ( S , i ) L4 ( S , i ) , P4 ( SP ) , P4 ( S , j ) \} \} S ) \\ T1 = Φ 1 ( + \{ Φ p \{ , L2 ( r , i ) , P 2 ( r , G ) , P 2 ( j ) \} \} + \\ \{ Φ p \{ Y3 ( r , i ) R3 ( b , i ) , L3 ( r , i ) , L3 ( w , i ) P3 ( j ) \} \} + \\ \{ Φ p \{ Y3 ( w , i ) L4 ( w , j ) , P4 ( w , P ) , P4 ( j ) \} \} )\end{matrix}$$

In here, “T0” refers to Scenario Function in which a medium a word belongs to are both an input screen identified with an identifier R (Receive),and an output screen identified with an identifier S (Send). “T1” refers to Scenario Function in which a medium the word belongs to, whereas the word helps determine semantic quality concerned with “T0”, are an input screen identified with an identifier r (read), an output screen identified with an identifier w (write) and printouts.

A right hand side of Scenario Function is a program to exteriorize a data code, or semantic quality which is “something that becomes a meaning” of the word, into a data field identified with that word on the medium.

In addition, “meaning” should be considered to be something (impossible to describe) which sprung in a heart (mind) of the person who watched the data code concretized into the data field identified with the word. Also, that “something” should be considered an incident which not only is conceived by a heart of a person, but also corresponds to a cause urging the person (a life body) to react (a life phenomenon such as behavior) to what has been conceived as long as life continues. Then, it is deemed that this reaction is nothing but an activity such as specifying, validating, verifying and testing, all of which are assumed to be necessary to perfect a program product. Suppose a number of times of the reaction is n, then the function P_{A}, which is a function performed by the program product actualized through activities such as specifying, validating, verifying and testing, can be transcribed as follows:

P_{A}≡T0ⁿ, P_{A}≠T0.

That is to say that a program T0 realized by a method of Lyee is not “what passed through n times of activities (that is, specifying, validating, verifying and testing, all assumed to be necessary to perfect a program product)”, but that “the same program (a right hand side of Scenario Function) being repeated n times is a program product functioning to satisfy a demand”. The fact that a program repeated n times is always the identical T0 leads to that T0 is not changeable for every individual activity. That is why, as a result, program T0 can be said to reach a status made through the activities repeated n times.

Among right hand sides of Scenario Function, “Φ 0(+{}R+{}+{}S)” and “Φ 1(+{}+{}+{})” are referred to as Pallet Chain Function, whose structure law, if described by a programming language, becomes a program.

“Φ p { , , , }” is referred to as Pallet Function, whose structure law, if described by a programming language, becomes a program. “Y n( )”, “R n( )”, “L n( )”, “L n( )”, “P n( )” are each generically referred to as Tense Control Vector, whose structure law, if described by a programming language, becomes a program.

In these,

“Y n( )” is referred to as Duplication Vector,

“R n( )” as R type Duplication Vector,

In “L n( )”,

“L 3(R,i)” and “L 3(r,i)” as Duplication Vector-type Homogeneity Vector;

“L 2(R,i)”, “L 3(S,i)”, “L 4(S,i)”, “L 2(r,i)”, “L 3(w,i)”, “L 4(w,i)” as Homogeneity Vector,

“P n( )” as, generically, Action Vector, in which “P 2(,G)” and “P 4(,P)” are referred to as Command Vector and “P n(,j)” are referred to as Routing Vector and Structural Vector. Now, a word corresponds to what becomes the smallest unit of semantics-assuming information uttered in a natural language by a person requiring a S/W development. On the other hand, Scenario Function is a function to obtain an intention (in other words, this is semantics), which is formed as a software development requirement by the development demander in an attempt to express a word as the word itself, with the word as a variable. That is to say that, as in a case of a function expressed as y=f (x) a variable is x, in case of Scenario Function a variable is word i, or more precisely an identifier concerning the word i (in the following, for convenience, it is defined to be valid to say “a variable of Scenario Function is word i”).

That is to say, T0=Φ0(+{Φ p {L n(word i) , , , }})}. Then, “the situation” in which a development requirer gave a development requirement of S/W as a sentence of a subset of a word is regarded as a medium such as “screens”, which person can directly recognize with his senses. Therefore, this “situation” does not always have to be only a so-called “screen” but may be anything a person can recognize with his senses. Identifiers R, S, r, w identifying such a medium are referred to as Definitive Identifier, an identifier i identifying a word pasted on the medium are referred to as Word Identifier, and, in case of Action Vector, identifiers G, P, j identifying the Action Vectors are referred to as Action Operator.

In “Φ 0(+{}R+{+{}S})” and “Φ 1 (+{}+{+{}})” of Pallet Chain Function in this Scenario Function, ‘(’ corresponds to a GET function (RECEIVE function or READ function) to get a data from the Definitive.

On the other hand, ‘)’ corresponds to a PUT function (SEND function or WRITE function) to put a data to the Definitive. ‘+’ corresponds to a function to activate a program. ‘{}D’ is meant to indicate that all the elements inside {} be gathered as long as the element belongs to Definitive having the Definitive Identifier D, more concretely that a program identified with D be included in an object to be activated.

In addition, for a group aggregated by subscript “2” and “4” in case of T1, and for a group aggregated by subscript “3” in case of T0 and T1, there is each only one program because D is not a subscript. Such a group is referred to as Pallet. Specifically a group collected with subscript “2” is called W02 Pallet, a group collected with subscript “3” is called W03 Pallet, and a group collected with subscript “4” is called W04 Pallet.

In addition, in “Φ p { , , , }” of Pallet Function in Scenario Function, ‘{}’ is meant to collect all elements in {}, that is all Tense Control Vectors. The range of the collecting is a program for every word corresponding to a second variable belonging to Definitive corresponding to a first variable of each Tense Control Vector expressed with <L (the first variable, the second variable)>. This collecting function may be replaced by CALL instruction or PERFORM instruction.

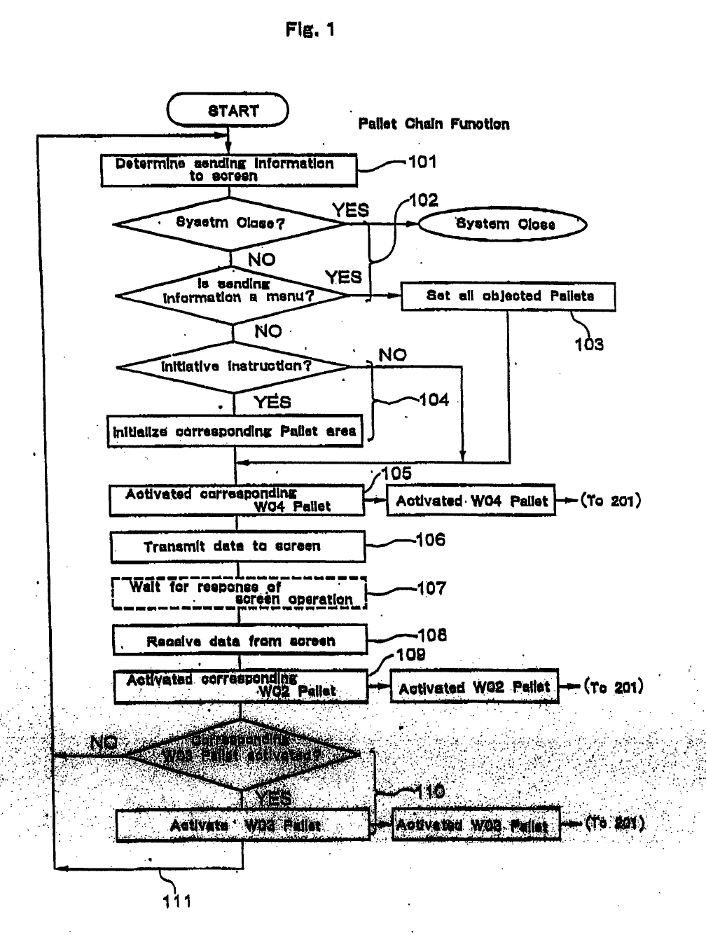

FIG. 1 to FIG. 3 are flowcharts for explaining a logical structures of the Pallet Chain Function, Pallet Function and Tense Control Vector (Homogeneity Vector), all of which are components of Scenario Function concerning the present invention. In other words, in Pallet Chain Function as shown in the figure above, firstly sending information to be displayed on a screen concerning a system is determined (step 101).

Next, data code in a data field recording an identifier of W04 Pallet editing the sending information is inspected (step 102).

When sending information to be displayed on the screen is a menu as a result of the second step, all pallets in the system are to be set as objects to be activated (step 103).

When sending information to be displayed on a screen as a result of step 102 is not a menu, a data field used is to be initialized in accordance with a necessity (a specification of new/continuation) (step 104).

Next, W04 Pallet editing the sending information is to be activated (step 105). Then, the data code edited by W04 Pallet in step 105 is to be transmitted to the screen (step 106).

As a result of this, user's terminating the operation is to be waited for (step 107) and the input data and operation instruction thereof on the screen is to be received (step 108). Next, W02 Pallet which accepts the received data code and the operation instruction is to be activated (step 109).

W03 Pallet or Pallet Chain Function is to be activated, if necessary (step 110). Then, these steps 101-110 are to be repeated endlessly up to the system confinement (step 111).

Next, Pallet Function is installed on W04 Pallet which is made for every screen displaying information transmitted by step 106 of Pallet Chain Function, on W02 Pallet to be installed also for every screen on which there was information received by step 108 of Pallet Chain Function, and on W03 Pallet which is installed only as one in a system.

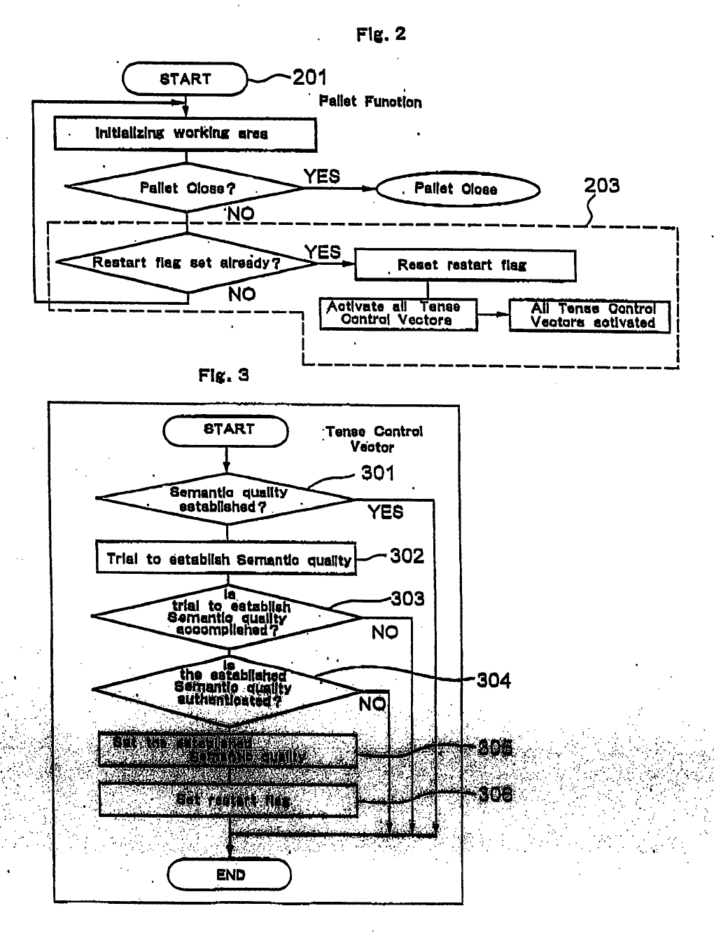

It is characteristic of Pallet Function to comprise a step to “repeat Tense Control Vector endlessly until semantic quality becomes valid (a re-starting flag is reset)”, wherein the Tense Control Vector is a third component of Scenario Function, as shown in FIG. 2.

In the last, Tense Control Vector (Homogeneity Vector) is installed for every word belonging to a screen (this word is word itself composing a sentence to explain an application business or an application function whose development is requested) and is implemented on W04 Pallet, W02 Pallet and W03 Pallet corresponding to the screen.

This Tense Control Vector comes in operation by being repeatedly activated “endlessly until semantic quality becomes valid (a re-start flag is reset)” by the afore-mentioned Pallet Function.

The logical structure of that Tense Control Vector is shown in FIG. 3.

That is to say, first, it is inspected whether semantic quality in a data field identified by the self word belonging to the self Pallet corresponding to a media does not become valid (or there is no data code) or else (step 301).

Next, when semantic quality of its own word does not become valid (there is no data code) in the data field in the step 301, a trial to embody the self word's semantic quality is to be attempted either by trying to substitute data code in a data field belonging to the self Pallet and identified with the data code in the date field belonging to the other medium and identified by the same identifier as the self word, or by trying to calculate by use of a data code existing in a data field belonging to the self Pallet and identified by an identifier which is not always the same as the self word (this embodiment of a data code through substitution and calculation is called “data combination”), and embodied semantic quality is to be generated in a working area data field identified by the self word belonging to the self Pallet concerning a medium identified with the screen (step 302).

Then it is checked whether semantics-assuming trial of the step 302 was effectuated or not (or there is a data code) (step 303).

If the semantic-quality trial is effectuated in the step 303, it is judged whether the embodied semantic quality of the self word is to be authentic or not (step 304).

In case of “authentic” in the step 304, the embodied semantic quality of the self word existing in the working area data field is to be set in a data field of the self word, as well as a flag indicating a failure status of Tense Control Vector is to be set valid (step 305).

Furthermore, flag for re-activating a trial to embody semantic quality only by way of data combination in the other Tense Control Vector is to be set (step 306).

In the above-mentioned description, “repeating endlessly up to the system termination” in Pallet Chain Function, “repeating an activation endlessly until the word's semantic quality becomes valid (a re-starting flag is reset)” in Pallet Function, and “setting a flag to re-activate the embodiment of semantic quality only by way of data combination in the other Tense Control Vector” in Tense Control Vector have a close relation described below.

That is to say, in Tense Control Vector, “a flag is set for re-activating the embodiment of semantic quality only by way of data combination in the other Tense Control Vector” in light of the fact that semantic quality of the self word is embodied.

Next, if the re-starting flag is set, Pallet Function re-activates Tense Control Vector after having initialized it.

In the re-activated Tense Control Vector, /if semantic quality of the self word is embodied, or /if the trial to embody semantic quality of the self word fails, or /if the embodied semantic quality of the self word is not authentic, then re-starting flag is never to be set because it terminates its operation without dealing any procedure.

When all Tense Control Vectors are in such a condition and when Pallet Function operates next, the W03 Pallet is to be closed because a re-starting flag is not set. Then after the following W04 Pallet is passed through, semantic quality of the word is transmitted to a screen by Pallet Chain Function.

If the user who watched the embodied semantic quality of the word instructs the system confinement, Pallet Chain Function autonomously closes, whereas if his instruction is other than the system close then W02 Pallet, W03 Pallet and W04 Pallet operate again by means of the logic that Pallet Chain Function comprises. In other words, new embodiment of semantic quality of the word is done according to the instruction that is not system confinement.

These Scenario Function's “embodiment of word's semantic quality” of Tense Control Vector can be regarded as what is gained from executing such activities as:

/specifying (step 302 of the Tense Control Vector),

/validating (steps 303 and 304 of the Tense Control Vector),

/verifying (step 301 of the Tense Control Vector), and

/testing (step 305 of the Tense Control Vector),

in n times (n does not have a limit) until the word's semantic quality becomes valid, against the word composing a sentence to explain an application business or an application function whose development is requested.

The conventional method was that a sentence to explain requirement, process event or conflict event and the coping method therewith, triggered by development requirement sentence, is composed into a document of specification by means of such arbitrary activity of an engineer as Specifying, Validating, Verifying and Testing, and is implemented based on the specification. In Lyee, an individual word is adapted to the law to the Tense Control Vector to directly write a program to be run, by which the semantic quality in the Tense Control Vector of all the words in the system becomes valid simultaneously, producing a result equivalent to that produced by specifying Validating, Verifying and Testing.

The Scenario Function's structure above-mentioned features can be regarded as nothing but our human's mental “thinking scheme”, or “consciousness and scheme(structure) recognition”, that is, “neuron's structure itself”.

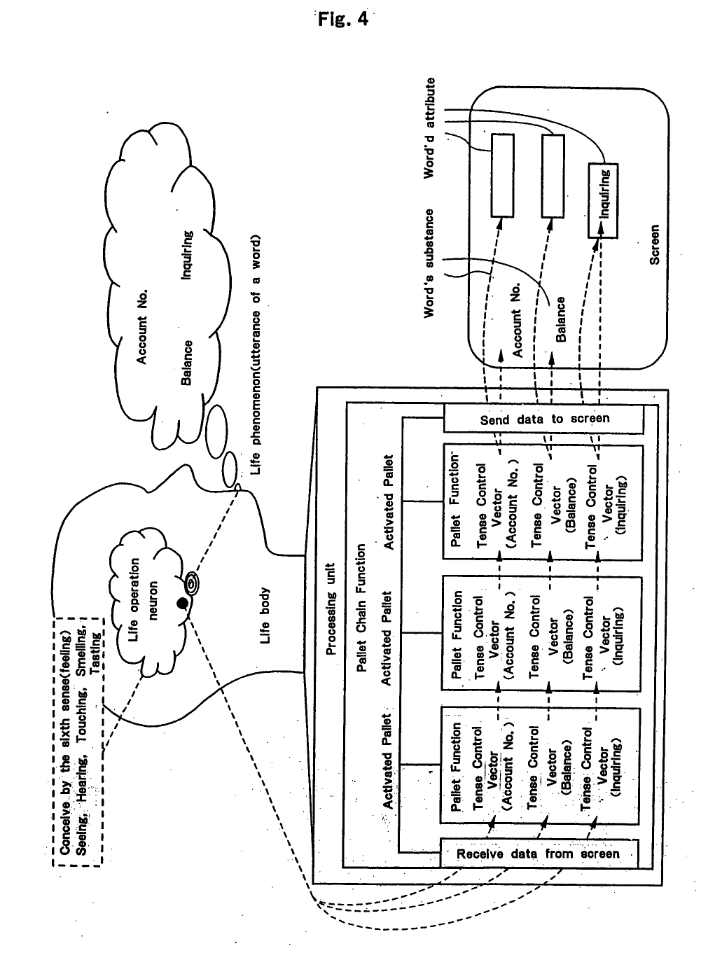

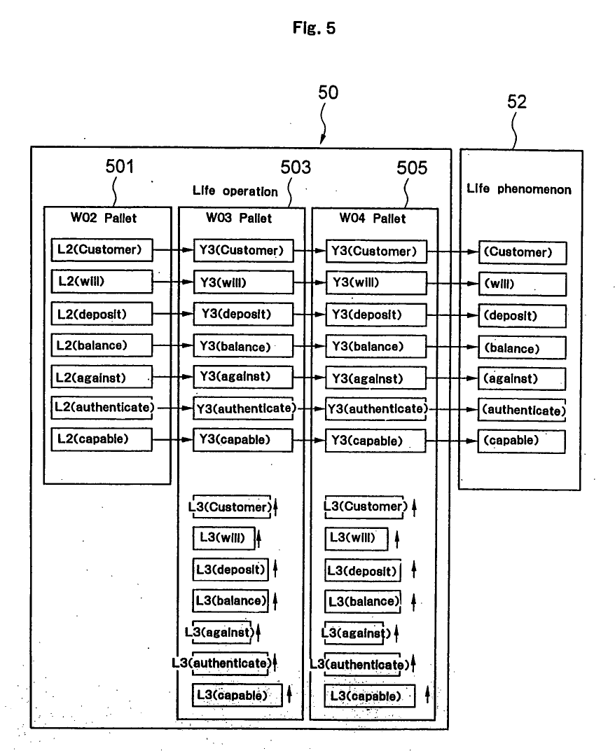

FIG. 4 is conceptual diagram explaining a relation between development requirement of a sentence that a word is grouped into, and a processing unit related to one embodiment of the present invention.

In other words, what an ultimately indivisible element realizing consciousness and recognition is embodied with a language is referred to as “a word” in Lyee. That is, “a word” is an ultimately indivisible element for actualizing “meaning” as well as for accomplishing a life operation and a life phenomenon thereon.

It is conceived that life phenomenon of our human behavior is what life operation in the mental world senses semantic quality for every word to consequently embody as a behavior of a utterance of a word, and what was enabled to be sensed by himself or the others.

What is described above in nothing but a utterance of a word to compose a development requirement to realize an application business and an application function as a S/W and, an utterance of a word composing the development requirement to implement the application business or the application function into various configuration of processing units such as stand-alone type S/W, client server type S/W, or client/front server/application server type S/W.

Scenario Function is nothing but what has established the universal law that the life action's scheme (structure) in the mental world has, which causes a life phenomenon of our human's such behavior.

In other words, regardless of whether we human beings are conscious or not, we sense by the sixth sense (feeling) what is embodied, and are given an opportunity of life operation by seeing, hearing, touching, smelling, testing, etc. And, semantics of the matter is caught as a conclusion of the life operation (that is, thinking operation) so that cognization is done, causing a life phenomenon of behavior and memory.

Life phenomenon and life operation are incessantly repeated as long as there is a life, just as the phenomenon of the embodied matter sensed by the sixth sense feeling regardless of being conscious/unconscious, so that an opportunity of life operation be given by seeing, hearing, touching, smelling, testing, etc.

The activities such as Specifying, Validating, Verifying and Testing of a S/W to be implanted are nothing other than trying to establish the semantic quality of word for explaining an application business and an application function by means of eternal repetition of such a life phenomenon and a life operation.

Next, this activity is explained by use of a structure of Scenario Function. At first, a development requirement is expressed in natural language as a life phenomenon of a behavior of a development requiring person. This development requirement is sentence that is made by words being collected.

As shown in FIG. 4, structure (structure of neuron) of life operation leading to its expression by development requiring person is to be regarded as what is edited as characteristics (attribute) and substance (type face of a word) belonging to the word in the same manner as expression is edited as substance (type face of a word) belonging to the word in the same manner as W04 Pallet of Scenario Function is operated, as well as what is expressed as language or behavior (indicated with a use of substance of a word onto a screen and with attribute which is a nature of belonging to the substance) by the same scheme as the operation of the step 106 (sending to a screen) of the afore-mentioned Palette Chain Function.

This development requirement is what a development intention of a development requiring person has embodied into as a substance and its attribute. The development intention should be perceived as an act performed by life activity (recognition operation) which not only sensed by the requirer's sixth sense the matter assumed by the already-embodied application business or application function, but also acts on seeing, hearing, touching, smelling, testing, etc.

In other words, because life activity not only sensed by the requirer's sixth sense the matter assumed by the already-embodied application business or application function, but also acts on seeing, hearing, touching, smelling, testing, etc. should be taken as equal to that the activity is performed in the same manner as the activity of step 108 (reception from a screen) of the Pallet Chain Function.

Caused by this reception from the screen, Specifying, Validating, Verifying and testing to see if the development requirement uttered (that is, displayed on the screen as a substance and attribute of the word) by the same system as the actions of W02 Pallet and W03 Pallet, satisfies the intention.

Therefore, it is led that an intention of a development requirement is a life operation to derive substance and attribute of a word to explain the matter that an already embodied application operation or application function assume.

The development requirement intention is conclusively satisfied if life phenomenon of the same mechanism as action of W02 Pallet, W03 Pallet and W04 Pallet, in which the substance and attribute of the word composing development requirement sentences are expressed in a form of indication on a screen, is developed in a reverse direction (that is, uttered words, substance and attribute are phased to Consciousness Unit-Link being the origin of the words that should have existed in the world of consciousness, then again W02 Pallet, W03 Pallet and W04 Pallet are traced.)

That is to say that when an activity of the same mechanism as that of W02 Pallet concerned with the word on the expressed development requirement, is implemented, next an activity of the same mechanism as that of W03 Pallet therewith is implemented, lastly an activity of the same mechanism as that of W04 Pallet therewith is implemented, then semantic quality of the word is concretized so that the concretized semantic quality can be grasped as an intention of the development requirement.

After all, Scenario Function is realized by activities such as Specifying, Validating, Verifying and Testing of a S/W to be implemented, an embodiment of the word's semantic quality.

On the other hand, in the conventional method other than “Lyee”, the above-mentioned activities or life operation and life phenomenon must be executed every time by arbitral experience, knowledge and ability without any law.

In Lyee, what establishes a mechanism to endure various conflict (collision) events between many events arising from application business or application function, and many events induced from various configuration of processing unit, in implementing application operation or application function as a S/W against various configuration of a processing unit, is life operation and life phenomenon of Specifying, Validating, Verifying and Testing. Thus in Lyee, such an activity as autonomous Specifying, Validating, Verifying and Testing is continuously prosecuted only by implementing the mechanism of Scenario Function, namely the words explaining various events of application operation, application function, or processing apparatus, by use of a programming language premising the mechanism of Tense Control Vector, as well as by activating W04 Pallet, W02 Pallet and W03 Pallet, which gathers those implemented words by the same scheme as an operation of Pallet Chain Function.

### THE BEST MODE FOR CARRYING OUT THE INVENTION

An embodiment of the present invention described referring to the drawings.

(1) Specifying, Validating, Verification and Testing Necessary for Implementing Software into a Stand-Alone Type Processing Apparatus.

Development requirement by a person requiring thereof are expressed by sentences which appear lacking the coverage and the exactness on the surface. For example, it is expressed like “I want you to develop the S/W by which a customer can ensure the deposit balance”, which is in a status lacking a word “a deposit ledger”.

This development requirement in fact is determined in life operation (thinking operation) of a person of development requirement and is expressed as a life phenomenon of a language or a behavior. In the present invention it is assumed that the life operation and the life phenomenon mentioned above are what is realized by the law equivalent to that of Scenario Functions, which underlies the depth-psychology of the development requirer.

In other words, the logical structure that each component of a Scenario Function has is described in a programming language and, as indicated in FIG. 4, and loaded in the inside of the processing unit (the main memory) before it operates.

FIG. 5 is a block diagram explaining a relation between life operation and life phenomenon when Tense Control Vector for every word that is a third component of Scenario Function concerning one embodiment of the present invention, is regarded as a neuron acting as life operation.

It is assumed that when processing unit is considered to be a life body, Tense Control Vector, for every word, which is a third component of Scenario Function, indwells in depths psychology of the life body like neuron acting as life operation 50 as shown in the figure above, by whose activity behavior of a word (life phenomenon 52) was done.

In other words, in FIG. 5, it is meant as follows:

/L2( ) is Tense Control Vector (Homogeneity Vector) to be installed on W02 Pallet 501.

/Y3( ) is Tense Control Vector (Duplication Vector) to be installed on Pallet 503.

/L3( ) is Tense Control Vector (Homogeneity Vector) to be installed on W03 Pallet 503.

/Y4( ) is Tense Control Vector (Duplication Vector) to be installed on W04 Pallet 505.

/L4( ) is Tense Control Vector (Homogeneity Vector) to be installed on W04 Pallet 505.

Each of these is assumed to be able to be considered neuron. What is described by inside the parentheses are words composing the development requirement which is expressed as determined in life operation by the neuron, and is expressed as life phenomenon 52. Specifying, Validating, Verifying and Testing for implementing a S/W satisfying a development requirement expressed as life phenomenon 52 is automously accomplished by each word's Tense Control Vector's being implemented and activated, at the same time faithfully meeting Scenario Function's law.

Therefore, Specifying, Validating, Verifying and Testing for implementing a S/W satisfying a development requirement are equivalent to implementing with faithfully satisfying the law of Scenario Function.

In other words, Scenario Function's Law, which is possessed by Tense Control Vector installed on W02 Pallet 501, is an action to determine semantic quality, namely a nature (attribute) belonging to the word, which is adequate to accomplish a real being such as appearance of each word embodied into by the development requirement as a language or behavior. In order to satisfy the Scenario Function's law for attaining this action, firstly attention should be paid to the fact that a word is expressed. This fact should have risen from neuron corresponding to the word existing and activating in depths psychology. An activity to realize the structure of the neuron as S/W is Verifying (exclusion of a mistake of the specification description).

In other words, activity to check whether a data field and Tense Control Vector corresponding to the word must be done so that a problem be assured not to exist.

The law of Scenario Function for this corresponds to the activating part of W02 Pallet 501 by Pallet Chain Function, to the activating part of the Tense Control Vector by Pallet Function of the activated W02 Pallet 501, and the step 301 portion of Tense Control Vector.

When a programming language named Visual Basic (this is transcribed into “VB” in the followings) is used, a law of an activating part of W02 Pallet 501 by Pallet Chain Function (step 109) is described as follows:

```
*********************
Rem***W02 Pallet activation Sub is CALLed.
Call W02 PALLET
********************
Public Sub W02PALLET( )
Rem***
  Select Case NextPltID
$ LOOP Definitive (a screen)
  Case PltID_kW02
    Call kW02
$ENDLOOP(a screen) // end of Definitive (a screen)
  End Select
End Sub
*********************
```

Here, k is an identifier to identify a sentence expressed as the development requirement, and it is an identifier of a screen displaying a word of the development requirement in case of an information processor. Now, assuming that an identifier to identify a sentence of the previously described development requirement is “balance inquiry”, an activating part of Pallet by Pallet Chain Function is described for each word, as follows:

Case PltID_balance inquiry W02

Call balance inquiry W02

What this program means is that, when a sentence expressed as a development requirement is regarded to be indicated via screen, a Pallet is activated unconditionally, namely without an argument. By this description, the specification described will never be activated with mistakes sustained by autonomously verifying by a compiler if there is no Pallet on which the corresponding Tense Control Vector is installed. This is, a mistake of a specification description is eliminated.

Next, a law of an activating part of Tense Control Vector by Pallet Function is described in VB, as: Call L2_k_I.

Here, i is a real being (type face) of a word expressed as a development requirement, and k is also an identifier to identify the sentence expressed as a development requirement. Now, assuming a identifier identifying a sentence of a previously described development requirement to be “balance inquiry”, then it follows that a Pallet's activating part for each screen by Pallet Chain Function is concluded as follows:

Call L2_balance inquiry_customer

Call L2_balance inquiry_will

Call L2_balance inquiry_deposit

Call L2_balance inquiry_balance

Call L2_balance inquiry_against

Call L2_balance inquiry_authenticate

Call L2_balance inquiry_capable

What this program means is that a function called Tense Control Vector for every word existing in a sentence expressed as a development requirement is activated unconditionally, namely without an argument. By this description, the specification described will never be activated with mistakes sustained by autonomously verifying by a compiler if there is no corresponding Tense Control Vector. That is, a mistake of a specification description is eliminated.

Next, a law of the step 301 of Tense Control Vector is that of inspecting whether semantic quality, an attribute of actualizing the word's substance (type face), is determined or not, that is, whether there is a data field to be indexed with the word's substance in W02 Pallet 501 and whether there is the data code which can check attribute in the data field. This law is described in VB as:

If W02. k. i=“”Then Exit Sub End If

Therefore, it follows that the first step of Tense Control Vector is described for every word as follows:

If W02.balance inquiry. customer=“” Then Exit Sub End If

If W02.balance inquiry. will=“” Then Exit Sub End If

If W02.balance inquiry. deposit=“” Then Exit Sub End If

If W02.balance inquiry. balance=“” Then Exit Sub End If

If W02.balance inquiry. against=“” Then Exit Sub End If

If W02.balance inquiry. authenticate=“” Then Exit Sub End If

If W02.balance inquiry. capable=“” Then Exit Sub End If

What this program means is to check (“If”) whether the data field (W02.balance inquiry.customer, W02.balance inquiry.will, W02.balance inquiry.deposit, W02.balance inquiry.balance, W02.balance inquiry.against, W02.balance inquiry.authenticate, W02.balance inquiry.capable) for every word existing in sentence expressed as a development requirement, exists in W02 Pallet 501 and whether data code does not exist (=“”) which can examine the attribute. By this description it is autonomously verified, by a compiler, if the corresponding data field does not exist.

These three parts treat only Definitive corresponding to the word expressed as development requirement and the sentence in which the word belongs, thus never twists on intention of a person who required the development. In other words, an intention of a development requirer is satisfied perfectly (100%).

Next, a part of step 302 of Tense Control Vector installed on W02 Pallet 501 corresponds to Specifying activity which defines a field belonging to W02 Pallet 501 identified by the word's real being (type face), namely an attribute appropriate to actualize the word's real being of type face. At the same time, that step 301 part is also a law to prosecute an activity of Validating and Verifying whether to be defined as an attribute as it is. This law is described in VB as:

If Is attribute (W02. k .i) Then Exit Sub End If

Here “i” is substance (type face) of a word expressed as a development requirement, “k” is an identifier to identify a sentence expressed as the development demand, and is an identifier of a screen displaying a word of the development requirement in case of an information processor.

Now, for example in case of a word “customer”, if the word, a number, is defined to have a “number attruibutr” as well as an “input attribute”, then the Specifying of step 302 is satisfied. Because Validating and Verifying are an inspection on whether an attribute of a field belonging to W02 Pallet 501 (W02.balance inquiry.customer) is of attribute of the just what it is (Numeric), the program thereof goes as follows:

If IsNumeric (W02. balance inquiry. customer) Then Exit Sub End If.

This means that not only an activity such as Specifying, Validating and Verifying but also implement is to have completed.

Lastly, the step 303 of Tense Control Vector installed on W02 Pallet 501 has a law of Testing in which, when the results of the above-mentioned Validating and Verifying were false, the following Pallet is caused to be able to determine that semantic quality, or the word's attribute, could not be accomplished.

This law is described in VB as:

W02. k .i_Non=True

Here, “Non” is meant to be a flag expressing that semantic quality was not able to be accomplished, and is referred to as “a refusal flag”.

Now, in case of a word named “a customer”, for example, a program goes as follows:

W02. balance inquiry. customer_Non=True.

This means that an activity of Testing and implement are to have been completed at the same time.

Next, the law of Tense Control Vector installed on W03 Pallet is an operation to generate a value (a data code indicating an amount) appropriate to actualize an individual word's substance, or the type face, in which the development requirement is embodied by a phenomenon of language or behavior. This operation is accomplished either by Duplication Vector or by Homogeneity Vector.

The first step of Duplication Vector has a law to check whether semantic quality of attribute is actualized in a field belonging to W02 Pallet identified with the type face of the word, that is, whether Specifying, Verifying and Validating are finished. This step is corresponding to an activity of Testing.

As for this law, it is enough to investigate that there are data in a field belonging to W02 Pallet identified with the type face of the word as well as that a failure flag is False.

This law is described in VB, as follows:

If W02. k .i=“” And W02. k .i_Non=True Then Exit SubEnd If

Now, for example, in case of a word named “a customer,” it goes as follows:

If W02. balance inquiry. customer=“” And W02. balance inquiry. customer_Non=True Then Exit Sub End If,

which means that the activity of Testing and implement are to have been completed at the same time.

Then the next second step has a law that, if semantic quality of attribute is established, the data code be set in a field belonging to W03 Pallet 503 identified with the type face of the word. This law is described in VB, as:

W03. k .i=W02. k .i.

Now, for example, in case of a word named “customer”, it goes as follows:

W03. balance inquiry. customer=W02. balance inquiry. customer,

which means that the activity of Specifying and Implement are to have been completed at the same time.

The first step of Homogeneity Vector has a law of execution of Testing on whether a value is not generated in a field belonging to W03 Pallet identified with the type face of the word, that is, whether Specifying completes by means of Duplication Vector. This law is described in VB, as:

If W03. k. i. <>“”Then Exit Sub End If

Now, for example in case of a word named “customer”, it goes as follows:

If W03. balance inquiry. customer <>“”Then Exit Sub End If,

which means that an activity of Testing and implement are to have been completed at the same time.

Then the next second step has a law that, if a value is not generated in the field belonging to W03 Pallet 503 identified with the type face of the word, a value of the word be generated in a working field belonging to W03 Pallet 503 identified with the type face of the word, which is equivalent to an activity of Specification. For example:

/For a word named “customer”, Homogeneity Vector for the word does not have a logic because the word, being of “Input” attribute, is generated in Duplication Vector;

/For a word named “will”, there is also no logic for a particle “will” as this word particle is of just “label attribute”.

/For a word named “deposit”, Homogeneity Vector for the word “deposit” does not have a logic because the word is generated by Duplication Vector owing to its being of “Input Attribute”.

/For a word named “balance”, Homogeneity Vector for the word does not have a logic because it is generated with the balance belonging to a ledger, owing to its being of “Out put Attribute”.

/For a word named “against”, there is also no logic for a particle “against” as this word particle is of just “label attribute”

/For a word named “authenticate”, Homogeneity Vector for the word “authenticate” does not have a logic because it is generated in Duplication Vector, owing to its being of “Input Attribute”.

/For a word named “capable”, there is also no logic for the word as this word is of just “label attribute”. As shown above, Specifying is done. This law is described in VB, as:

W03_WORK. k .i=value generation formula.

Now, for example in case of a word the “balance”, the word was specified as “generation with the balance belonging to a ledger”. This leads to:

W03_WORK. balance inquiry.balance=W03. ledger.balance

which means that an activity of Specifying and Implementing have been completed simultaneously.

Here, it is concluded that a word, which has not been embodied as “balance belonging to ledger” of an initial development requirement but has been latent in the initial development requirement, has risen by performing an activity so that a law of Specifying be satisfied. The relationship between the affect done by this new word “balance belonging to ledger” and the law of Scenario Function will be discussed later.

The next third step has a law of an activity corresponding to Verifying which checks whether the above-mentioned second step was established (or a value was able to be generated) or not. This law is described in VB as:

If W03_WORK. k .i=“” Then Exit Sub End if.

Now, for example in case of a word balance”, it goes as follows;

If W03_WORK. balance inquiry. balance=“”Then Exit Sub End If.

The reason why this corresponds to Verifying is that the value generation formula must be right in order for the above-mentioned second step to be established.

For example in order for a value generation formula:

W03_WORK. balance inquiry. balance=W03. ledger. balance

to be necessarily established, it is necessary for there to be a data field of a right hand side, for which purpose a word corresponding to the right hand side must be defined. At this point, however, a word “the balance on a ledger” does not appear on FIG. 5.

As a result, this program will be terminated abnormally by all means. It is an object of Verifying that this ABEND be not caused. Therefore, by satisfying the law of the third step, an activity is inevitably needed that fulfills a word “the balance on a ledger”, which will run short in this situation, as a word explaining this development requirement.

As a result, an activity of Vertification and Implement have been eventually completed at the same time. Because a word of “the balance on a ledger” belongs to a medium of a ledger in which semantic quality of Value plays a role of a storage, it concludes not only that the word becomes being dealt with in Scenario Function T1, based on Scenario Function's law, but also that the word can belong to Scenario Function T0 as a boundary word base on the law of Scenario Function. In this way, If Specification generating semantic quality of Value is executed so that a law of Scenario Function be satisfied, perfect Specification is achieved by itself.

The next fourth step has a law of an activity corresponding to Validating to determine whether to authenticate or not the embodied semantic quality of Value when the third step is established. This law is to be necessary merely when value generation formula of the above-mentioned second step operates in plural words.

In other words, in case of a substitution formula for a single word into the Value generation formula, Verifying is done in the above-mentioned third step, which leads Validating to be done as a result, whereas in plural words, even if Verifying is done the generation may not necessarily be established in a mathematical sense. For example, there must be a semantic-quality value in either B or C in order for the numeration A=B+C to be inevitably established.

From these reasons described above, only when a value generation expression of the above-mentioned second step operates in plural words, an activity corresponding to Validating to examine a condition to make the generation expression inevitably established is performed in the fourth step.

For example, in case of “A=B+C”, it goes as follows:

If W03. balance inquiry. B=“”And W03. balance inquiry. C=“”Then ExitSub EndIf

which means that an activity of Validating and Implement are to have been completed at the same time.

The next fifth step and the sixth step have a law of an activity of Validation to set in the self data field the semantic quality of Value generated in the above-mentioned working data field, to make accepted a flag indicating a refusal status of the Tense Control Vector, and to set a flag for reactivating establishment of semantic quality of Value only by data combination in all the other Tense Control Vectors belonging to W03 Pallet 503, in case the fourth step is authentic. This law is described in VB, as follows:

W03. k .i=W03_WORK. k .i

W03. k .i_Non=False

W03.Recall_FLG=True

In here, “Non” is meant to be a “refusal flag” indicating that semantic quality has not been established, whereas “W03.Recall_FLG” is called “restart flag” for reactivation. Now, for example in case of a word “balance”, it goes as follows:

W03. balance inquiry.balance=W03_WORK. balance inquiry.balance

W03. balance inquiry.balance_Non=False

W03.Recall_FLG=True

which means an activity of Validating and Implement are to have been completed at the same time.

As mentioned above, as a result that semantic quality of Value related to this word is established and that a restart flag is set, all Tense Control Vectors implemented on W03 Pallet begin to operate again. Then, all Tense Control Vectors will be repeated endlessly until reaching Synchronous state if semantic quality of Value is established in the first step, or if semantic quality of Value is not established in the third step, or if semantic quality of Value is not authentic in the fourth step.

That is to say, it is concluded that a perfect software that is not unstable is generated if semantic quality of Value is established in the first step in every word, or if semantic quality of Value is not established in the third step, or if semantic quality of Value is not authentic in the fourth step, without endless times of Specifying, Validating, Verifying and Testing at the same time ABEND in the middle.

The serial tasks mentioned above are referred to as synchronous Specifying, synchronous Verifying, synchronous Validating and synchronous Testing. In addition, when semantic quality of Value is not established in the third step, or when semantic quality of Value is not authentic in the fourth step, it is embodied as reported events to the users by Tense Control Vector installed on the next W04 Pallet, because the case is limited either to an operated event on humans who use an implemented S/W or to a failure event of a processing unit.

Next, Tense Control Vector to be installed on W04 Pallet 505 has a law to act to edit semantic quality related to attribute of “format” appropriate to actualize a real being of individual word's type face, which the development requirement has been exteriorized into by a phenomenon called language or behavior. This operation is achieved by Duplication Vector and Homogeneity Vector.

The first step of Duplication Vector investigates whether semantic quality of attribute is established in a field belonging to W02 Pallet 501 identified with the type face of the word, and, if it is established there, and sets it in a field belonging to W04 Pallet 505 identified with the type face of the word. The law is that, if it is not established, it is investigated whether semantic quality of attribute is established in a field belonging to W03 Pallet 503 identified with the type face of the word and, if it is established there, it is set in a field belonging to W04 Pallet 505 identified with the type face of the word, which is equivalent to activities of Testing, Validating and Specification. This law is described in VB, as follows:

```
  if W02. k .i <> “ ” And W02. k .i_Non = False Then
    W04. k .i = W02. k .i
  Else
    If W03. k .i <> “ ” Then
        W04. k .i = W03. k .i
    End If
  End If
Now, for example in case of a word “balance”, it goes as follows:
  If W02. balance inquiry. balance <> “” And W02. balance inquiry.
  balance _Non = False
  Then
    W04. balance inquiry. balance = W02. balance inquiry. balance
  Else
      if W03. balance inquiry. balance <> “” Then
        W04. balance inquiry. balance= W03. balance inquiry. balance
      End If
  End If
```

This above leads to a conclusion that an activity of Testing and Implement are to have been completed at the same time.

The first step of Homogeneity Vector has a law corresponding to an activity of Validation to check whether semantic quality of Value is established in a field belonging to W04 Pallet identified with the type face of the word, that is, whether semantic quality of Value is established by means of Duplication Vector. However, some semantic quality must be established because having activated W02 Pallet 501 and W03 Pallet 503 without ABEND means that Specifying, Verifying, Validating and Testing so far are perfect. Therefore, a result of this the first step must always be true and have to be pushed forward to the second step. This law is described in VB, as follows:

```
  If W04. k .i <> W04. k .i Then
    Exit
  End If
Now, for example in case of a word of “balance”, it goes as follows:
  if W04. balance inquiry. balance <> W04. balance inquiry. balance
  Then
    Exit Sub
  End If
```

The next second step has a law corresponding to an activity of Specification to edit semantic quality of Value into a format appropriate to establish a real being of the word's type face in a field belonging to W04 Pallet 505 identified with the word's type face. Editing into a format appropriate to establish the real being of the word's type face corresponds to Specifying, which is editing, for example, a word “balance” into a format to “give a currency sign to beginning of a number”. This is described in VB as:

W04. balance inquiry. balance=“¥”+W04. balance inquiry. balance

which means that Specifying and Implement have been completed simultaneously. The next third step has a law corresponding to an activity of Specifying to check whether Tense Control Vectors of the above-mentioned W02 Pallet 501-W03 Pallet 503 achieved their purposes, and, if a failure flag was set, to report a failure in a word named MSG. This law is described in VB as follows:

```
  If W02.k.i_Non= True Then
    MSG = “W02.k.i error”
  Else
    IfW03.k.i_Non= True Then
      MSG = “W03.k.i error”
    End If
  End If
Now, for example in case of a word “balance”, it goes as follows:
  If W02. balance inquiry. balance_Non = True Then
    W04. balance inquiry .MSG = “W02. balance inquiry.balance error”
  Else
    IfW03. balance inquiry. balance_Non = True Then
      W04. balance inquiry .MSG = “W03. balance inquiry.balance
      error”
    End If
  End If
```

The above concludes that Specifying and Implement as opposed to an error event are completed at the same time.

In this way, without making a document of Specification, Validation and Verification to implement a S/W which satisfies a development requirement from the words expressed to indicate the requirement, a S/W equivalent to those effectuated by such activities as Specification, Validating, Verifying and Testing can be completed, only by implement with programming language, which is deducting thinking mechanism in a mental field leading to an utterance of the word into Scenario Functions law.

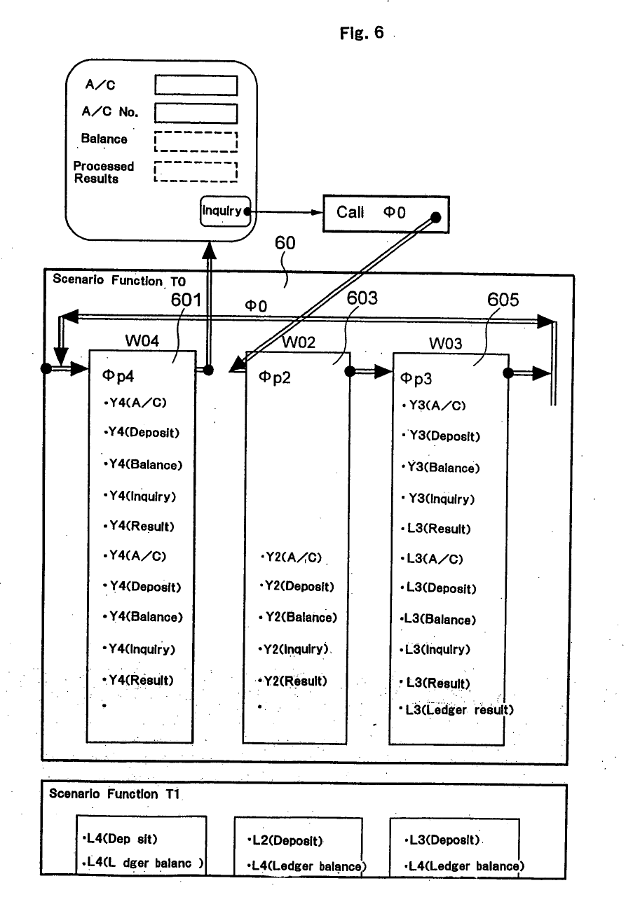

FIG. 6 is a block diagram explaining configuration and order of the operation of the program that is implemented in this way.

A double arrow line is a program of Pallet Chain Function Φ 0(60) in the figure above. Φ p4 (601), Φ p2 (603) and Φ p3 (605) are Pallet Functions. Y n( ) is Duplication Vector, and L n( ) is Homogeneity Vector. Action Vector is omitted out of a chart.

By the way, an expression of a development requirement is equivalent to a screen display. And, a word on a screen is thought of as the matter that semantic quality of substance and attribute are determined and expressed by an operation of neuron which can be considered to be equivalent to the law held by five kinds of Tense Control Vectors for each of the words.

Because the law that Tense Control Vector comprises is, as explained above, what embodied a law of Specifying, Validating, Verifying and Testing for determination of the word's semantic quality, the operation of this Tense Control Vector amounts to Specifying, Validating, Verifying and Testing of a word expressed as a development requirement to be done simultaneously.

(2) Specifying, Validating, Verification and Testing Necessary to Implement S/W onto a Client/Server Type Processing Unit

As have been mentioned above, a demand to want to develop S/W is expressed by a sentence comprising of words of a natural language. If structure of a thought in mental area leading to an expression of one word to compose the sentence is considered to be equivalent to a mechanism of Scenario Function, it is concluded that the word is expressed not by Value being set only in relation with a nature to belong to substance of the word (attribute), but by a restart flag being set as an extension that a value of a word of one is set, which results in all Tense Control Vectors, for all the words belonging to W03 Pallet including the balance on a ledger related to the word, to be synchronously Specified, synchronously Verified, synchronously Validated, and synchronously Tested.

That is to say, that implementing an application business and an application facility as S/W against standalone type amounts to the development require imaging the application business or the application facility in a mental area. A standalone type is one embodiment when life body of a development requirer is regarded as a processing unit and his thinking operation is considered to be S/W prescribed with the Scenario Function that is stored in the main memory of the processing unit.

Implementing this application business as client server type S/W, for example, amounts to imaging an application business or an application facility within two life bodies which originally was imaged with in one life body.

In exerting within two life bodies an application business or an application facility, which originally were to be implemented within one life body, it is mandatory to cope with these as if two capricious life bodies' conflict events between these requirement events and process events were operating as one life body. These coping method is so-called protocol concept.

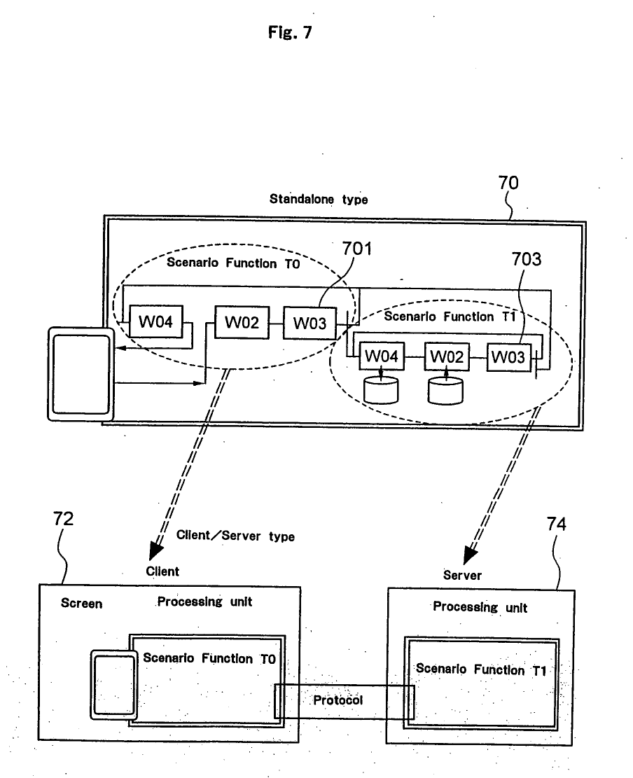

FIG. 7 is a conceptual block diagram to explain software in which two processing units carry out an application business and an application facility in two parts, namely a client and a server, concerning one embodiment of the present invention, from a view point of Scenario Function.

If described by a law of Scenario Function, as shown in this Figure, implementing in two processing unit, client 72 and server 74, an application business or an application facility on one processing unit 70, can be explained as allocating:

/Scenario Function T0 to the client; and

/Scenario Function T1 to the server.

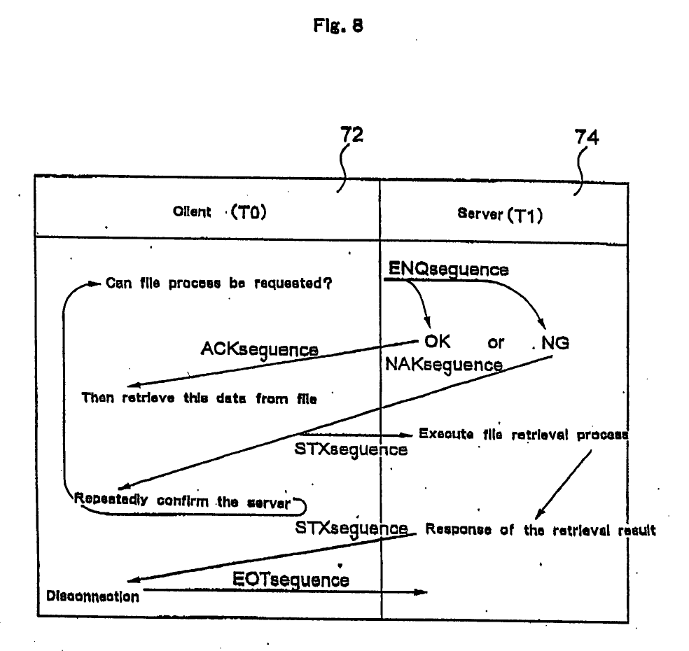

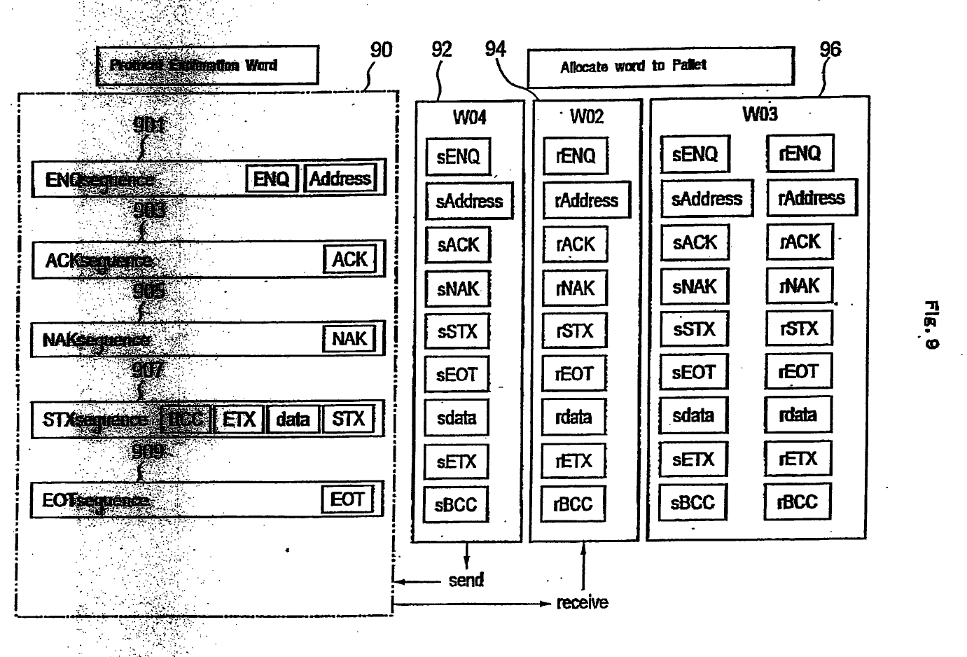

In case of a standalone type 70, the relationship between Scenario Functions T0 and T1 was based on an assumption of one life body, by which a protocol was unnecessary at all, and both sides contacted consecutively with each other through W03 Pallet (701, 703). On the other part, in case of a client/server model (72, 74), two life bodies each perform autonomous life operation and the life phenomenon, which allow a conflict event to occur here. However, a protocol must be autonomously done between both life bodies because a mission to effect an application business and an application facility cannot but be maintained. The FIG. 8 is a sequential chart to explain a protocol which is necessary for actualizing one object between both life bodies.

As shown in the figure above, what used to be a concept of protocol is actualized only by applying a word, which is related to the protocol indicated in the FIG. 8 and is expressed from the two life bodies in order to perform the application business/facility, to the law of Scenario Function T1 and implementing with a programming language, and not by making protocol state transition diagram and decision table, all of which have been considered indispensable for implementing as S/W the application business/facility departedly in two processing units, a client and a server.

Specifically, as shown in FIG. 9, it is realized by sticking a word concerning a protocol (901, 903, 905, 907, 909) on a (variable) identifier insertion point of a fixed form in each of Pallet W04 (9), W02 (94), W03 (96), each of which is a program to embody Scenario Function.

In this connection, W04 (92), W02 (94) and W03 (96), except for these (variable) identifier insertion points of a fixed form, have a predetermined structure regardless of a kind/facility of a program, a difference of a word, etc., which, as shown above, is brought about by the law possessed by Scenario Function.

(3) Specifying, Validating, Verification and Testing Needed to Implement S/W to Client/Front Server/Application Server Type Processing Unit

Next it is contemplated how in Scenario Function is handed an activity of Specifying, Validating, Verification and Testing when implementing S/W to effect an application business and an application facility under a processing unit configuration of Internet comprising of client/front server/application server.

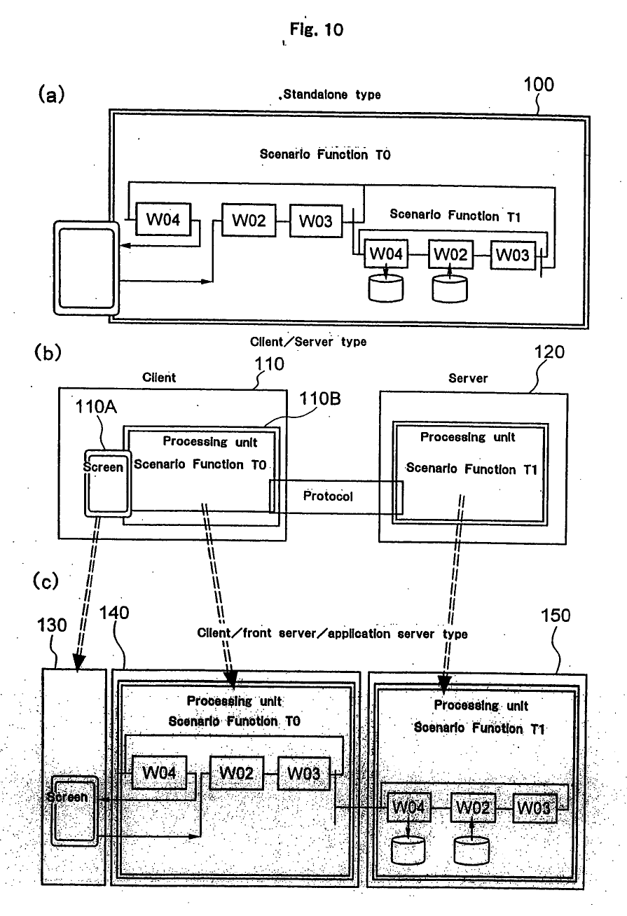

FIG. 10 is a conceptual block diagram to explain from a viewpoint of Scenario Function about S/W in which three processing units perform an application business/facility concerning one embodiment of the present invention departedly in a client, a front server and an application server.

Processing unit configuration of Internet is seen as if seemingly it is configured with three layers as shown in the figure above when a client/server model is considered to have two layers. The reality, however, is that the screen part 100A and processing unit part 110B of client part 110 in a client/server comprising of two layers (b) are split apart (130, 140). This is a method in which screen definition is done with HTML, a language peculiar to Internet, which used to be done in a client/server type (b), as well as a method to control the screen by standardized S/W named browser and a script.

Therefore, basically, in dealing with Specifying, Validating, Verification and Testing when implementing an application business and an application facility as S/W on a processing units 140,150 of client/front server/application server model (c), it is only needed to transmit to a screen 130 information defined in HTML between client (screen 130) and front server 140, to implement the information defined in URL and received from the screen 130 in accordance with a law of Command Action Vector, and to implement the other part in the same manner as in the case of client/server type(b).

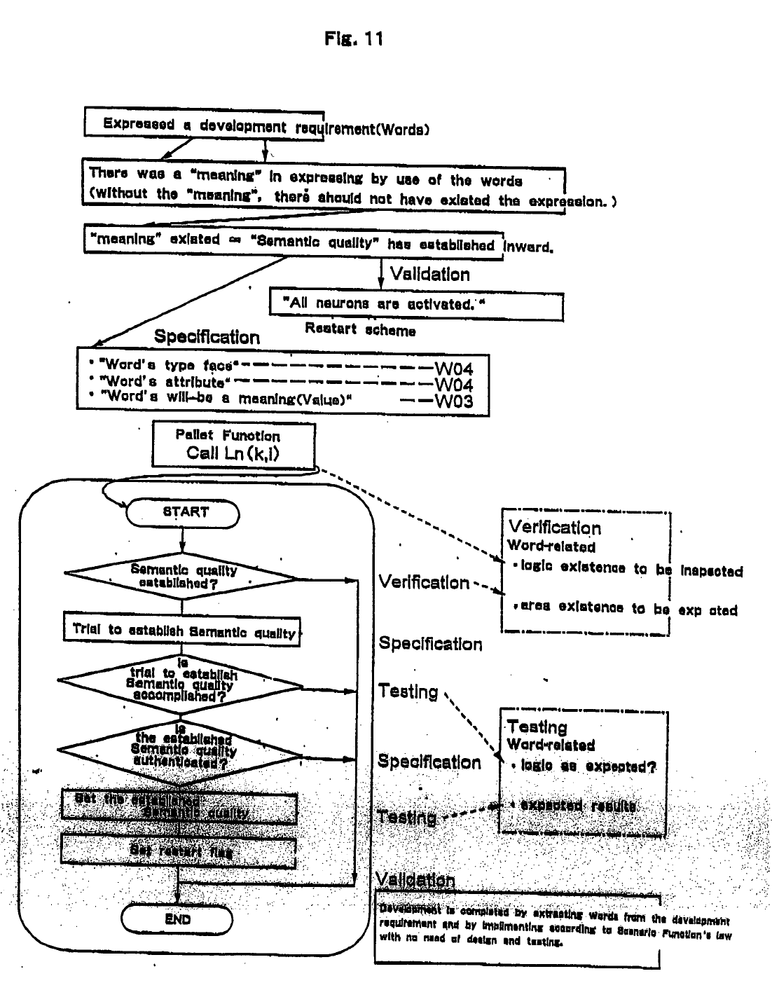

FIG. 11 is a conceptual chart that conceptually expresses a point explained in detail above.

As shown in this Figure, it is possible to complete S/W requirement equivalent to those produced through activities being done such as Specifying, Validating, Verifying and Testing, only by implementing by use of structure of a thought in mental area leading an utterance of a word and applying it to a law of Scenario Function with a programming language, and not by making a document such as Specification, Validation and Vertification for implementing S/W to satisfy the development requirement from the word that is spoken to express a development.

As discussed in detail above, according to the software synchronous specifying method, validating method, verifying method and testing method concerning the present invention, it is possible to attain an establishment equivalent to those gained from endless repetition of activities such as Specifying, Validating, Verifying and Testing needed to make S/W perfect, only by directly implementing with a programming language the mechanism of Scenario Function that embraces semantic-quality determining-structure for a word by an endless repetition structure.

### Industrial Applicability

As described in detail above, according to the present invention, it is possible to complete S/W equivalent to those gained from performing activities such as Specifying, Validating, Verifying and Testing, by implementing with a programming language a law itself of Scenario Function embracing semantic-quality determining-structure for a word by an endless repetition structure. In addition, the present invention is not limited to the embodiment described above and various transformation thereto within a range of technical conception of the present invention is possible. For example, a method to realize S/W was mainly explained in the embodiment above, but it is also possible to program a method for implementing such software.

In addition, in the embodiment above, definitive is not limited to the thing described above but also extendable to various medium including transmission medium and a paper medium, for example.

What is claimed is:

1. A software synchronous specifying method comprising:
a first step to determine sending information for displaying on a screen in a system to be developed;
a second step to examine a data code in a data field recoding an identifier of W04 Pallet which edits the sending information;
a third step, if as a result of the second step the sending information for displaying on a screen is a menu, to set all Pallets in the system as an object to be activated;
a fourth step, if as a result of the second step the sending information for displaying on a screen is other than a menu, to initialize a used data field if needed (that is, a designation of new/cotinuation);
a fifth step to activate W04 Pallet which edits the sending information;
a sixth step to transmit to the screen the data code edited by the W04 Pallet in the fifth step;
a seventh step to receive the input data code and the process instructions thereof operated on the screen;
an eighth step to activate W02 Pallet which accepts the received data code and process instructions;
a ninth step to activate either W03 Pallet or Pallet Chain Function associated with T1 in accordance with necessity; and
a tenth step to repeat the first step to the ninth step endlessly up to system confinement.

2. A software synchronous validating method comprising:
a first step to determine sending information for displaying on a screen in a system to be developed;
a second step to examine a data code in a data field recoding an identifier of W04 Pallet which edits the sending information;
a third step, if as a result of the second step the sending information for displaying on a screen is a menu, to set all Pallets in the system as an object to be activated;
a fourth step, if as a result of the second step the sending information for displaying on a screen is other than a menu, to initialize a used data field if needed (that is, a designation of new/cotinuation);
a fifth step to activate W04 Pallet which edits the sending information;
a sixth step to transmit to the screen the data code edited by the W04 Pallet in the fifth step;
a seventh step to receive the input data code and the process instructions thereof operated on the screen;
an eighth step to activate W02 Pallet which accepts the received data code and process instructions;
a ninth step to activate either W03 Pallet or Pallet Chain Function associated with T1 in accordance with necessity; and
a tenth step to repeat the first step to the ninth step endlessly up to system confinement.

3. A software synchronous verifying method comprising:
a first step to determine sending information for displaying on a screen in a system to be developed;
a second step to examine a data code in a data field recoding an identifier of W04 Pallet which edits the sending information;
a third step, if as a result of the second step the sending information for displaying on a screen is a menu, to set all Pallets in the system as an object to be activated;
a fourth step, if as a result of the second step the sending information for displaying on a screen is other than a menu, to initialize a used data field if needed (that is, a designation of new/cotinuation);
a fifth step to activate W04 Pallet which edits the sending information;
a sixth step to transmit to the screen the data code edited by the W04 Pallet in the fifth step;
a seventh step to receive the input data code and the process instructions thereof operated on the screen;
an eighth step to activate W02 Pallet which accepts the received data code and process instructions;
a ninth step to activate either W03 Pallet or Pallet Chain Function associated with T1 in accordance with necessity; and
a tenth step to repeat the first step to the ninth step endlessly up to system confinement.

4. A software synchronous Testing method comprising:
a first step to determine sending information for displaying on a screen in a system to be developed;
a second step to examine a data code in a data field recoding an identifier of W04 Pallet which edits the sending information;
a third step, if as a result of the second step the sending information for displaying on a screen is a menu, to set all Pallets in the system as an object to be activated;
a fourth step, if as a result of the second step the sending information for displaying on a screen is other than a menu, to initialize a used data field if needed (that is, a designation of new/cotinuation);
a fifth step to activate W04 Pallet which edits the sending information;
a sixth step to transmit to the screen the data code edited by the W04 Pallet in the fifth step;
a seventh step to receive the input data code and the process instructions thereof operated on the screen;
an eighth step to activate W02 Pallet which accepts the received data code and process instructions;
a ninth step to activate either W03 Pallet or Pallet Chain Function associated with T1 in accordance with necessity; and
a tenth step to repeat the first step to the ninth step endlessly up to system confinement.
